(19) United States
(12) Patent Application Publication
(10) Pub. No.: US 2012/0069439 A1
(43) Pub. Date: Mar. 22, 2012

(54) Demisting Side Mirrors

(76) Inventor: Russell Calla, Winthrop, MA (US)

(21) Appl. No.: 13/236,179

(22) Filed: Sep. 19, 2011

Related U.S. Application Data
(60) Provisional application No. 61/403,509, filed on Sep. 17, 2010.

(51) Int. Cl. G02B 7/182

(52) U.S. Cl. 359/509

(57) ABSTRACT

A demisting mirror assembly is provided. The demisting mirror assembly having a substantially hollow interior, an air blower with an outlet positioned within the interior of the housing, an air outlet, and a mirror on a front face of the housing. An air outlet may be directed at a second mirror to provide additional demisting

### BACKGROUND OF THE INVENTION

1. Field of the Invention

The present invention relates generally to the demisting of mirrors. More particularly, the present invention relates to devices that utilize an air blower to demist a mirror.

2. Description of Related Art

The misting over of a mirror, for example mirrors adjacent to a shower or sink, is a problem that one frequently encounters. This represents an annoyance which renders the mirror temporarily unusable for such tasks as shaving, grooming, and applying makeup. A common approach to the problem is to wipe the mirror off with a dry towel, however, this usually provides only temporary relief since the moisture remaining in the bathroom environment will tend to continue to condense and cloud the mirror surface. Other common efforts at remedying this problem involve the opening of a bathroom window, if there is one, or opening the bathroom door so as to vent the airborne moisture. Unfortunately, this method does not work instantly and may affect one's comfort, convenience, and privacy. Another way to combat the problem is to pre-treat the mirror by spraying it with a chemical substance that minimizes the condensation of moisture on the mirror surface; however, there are several reasons why a chemical solution to the problem is not desired.

Hand held hair dryers are a very common household appliance. Many people use a hair dryer to style their hair daily. However, the motor or blower section of some of the larger sized hair dryers will not fit in a standard vanity cabinet drawer making storage of the product awkward when not in use. Such an appliance is often left sitting on the sink or vanity basin when not in use taking up counter space. Additionally, some typical bathrooms and salon work areas have extremely limited counter and drawer space. A user may wish to use the limited space for items other than a hair dryer.

Therefore, what is needed is a device that may efficiently and easily demist a mirror. Further, what is needed is a device that may conveniently store a hair dryer or other portable air blower.

### SUMMARY OF THE INVENTION

The subject matter of this application may involve, in some cases, interrelated products, alternative solutions to a particular problem, and/or a plurality of different uses of a single system or article.

In one aspect, a demisting mirror assembly is provided. The demisting mirror assembly comprises a housing forming a substantially hollow inner portion, an aperture in its surface, and an air outlet, an air blower may be removably mounted to the housing, and a mirror may be attached to a front face of the housing.

In another aspect, a mirror demister for an existing mirror is provided. The mirror demister comprises a housing forming a substantially hollow interior portion, an aperture, and an air outlet, an air blower may be removably mounted to the housing, the housing may be positioned adjacent to the existing mirror, an air blower removably mounted to the housing, and a second mirror may be attached to a front face of the housing.

### BRIEF DESCRIPTION OF THE DRAWINGS

FIG. 1 provides a front view of an embodiment of the mirror assembly.

FIG. 2 provides a cutaway view showing the hollow interior of an embodiment of the mirror assembly.

FIG. 3 provides a perspective view of a rear of an embodiment of the mirror assembly.

FIG. 4 provides a view of two demisting mirrors mounted on opposite sides of an existing mirror.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a demisting mirror assembly that utilizes air from an air blower to demist the mirror. The mirror described herein may be easily incorporated to existing mirror mounting areas. Further, the mirror may be mounted adjacent to a pre-existing conventional mirror, and may utilize heated air to demist both the demisting mirror assembly contemplated herein, and an adjacent conventional pre-existing mirror. The demisting mirror may further serve as a holster for a traditional hair dryer and may utilize the hair dryer as the source of heated air to demist the mirror. Demisting a mirror in this fashion provides an efficient and convenient way to use a mirror after it has been misted, and also as a convenient and neat storage place for a hair dryer.

In one aspect, a demisting mirror assembly, or demisting apparatus, is provided. The assembly may have a housing that provides the structure for the mirror assembly. The housing may define an aperture sized to receive an air blower. The housing may also have a mirror attached to its front face, the mirror being capable of being demisted via the air blower inserted within the aperture formed by the housing.

The housing of the mirror assembly may provide structure for the mirror and the demisting elements. The housing may be of any size and shape capable of supporting a mirror and an air blower that is also capable of being mounted to a wall, or placed on a surface. In one embodiment, the housing is substantially box shaped with a rectangular cross section. In another embodiment the housing is substantially box shaped with a triangular cross section.

The housing may be constructed of any material capable of supporting a mirror and an air blower that is capable of being mounted to a wall or placed on a surface. Materials of which the housing can be made include, but are not limited to, mirrored glass, glass, plastics, metals, woods and composite material. Preferably, the material is water resistant and capable of existing in a humid environment without structural breakdown or corrosion. The housing may be manufactured using methods known to those skilled in the art such as molding, casting, bending of sheet metal, attachment of multiple flat plates, and the like.

The housing may have a front face with a mirror attached thereto. Further the housing may have rear, top and bottom faces that may be mounted to a wall, set on a surface or hung from a ceiling.

The housing may form an aperture that provides fluid communication to its substantially hollow interior. In one embodiment, the aperture may be substantially circular and sized to receive a standard sized hair dryer or other portable air blower. In a further embodiment, the aperture may serve as a storage holster for a hair dryer. In this embodiment, the aperture may be positioned and designed to hold and secure the hair dryer neatly, and to provide convenient access for conventional hair dryer use. In one embodiment, the aperture may be positioned on a top of the housing, such that an air blower may be supported and removably secured, and at the same time, easily accessible by a user.

The housing may further include cord guides to guide the cord of the air blower along its surface. The cord guides may be in the form of clips, hooks, and the like. Embodiments having cord guides may further enhance the convenience and neatness of the blow dryer support and storage.

In one embodiment, the housing may have ducting attached to the aperture that may direct air flow to a front face of the housing, thereby heating the housing, and in turn the mirror, which may demist the mirror. Further, the ducting may be directed to an air outlet formed by the housing to allow the escape of inlet air.

In one embodiment, the demisting mirror assembly may be designed to be mounted adjacent to an existing conventional mirror, to provide demisting both to the mirror of the mirror assembly as well as the existing conventional mirror. The air outlet so formed may serve to direct an airflow along the surface of the adjacent conventional mirror. In this embodiment, the air outlet formed by the housing may be formed as a long narrow aperture that runs from a top to a bottom of the housing. In this embodiment, the mirror assembly may be attached adjacent to the conventional mirror such that the air outlet is directed towards the conventional mirror. The demisting mirror assembly may be attached to a wall using methods known in the art such as adhesive, bolting, screwing, nailing or hanging. Alternatively, the mirror assembly may be hung from a ceiling or placed on a surface adjacent to the existing conventional mirror. In this embodiment, the air from the air blower is initially directed at the front face of the housing to heat the mirror attached thereto, and then is directed out of the air outlet and over the surface of the conventional mirror, thereby demisting both mirrors.

In another embodiment, two demisting mirror assembly housings may be employed. A first demisting assembly housing may be mounted to, or adjacent to, a first side of an existing, conventional mirror. A second demisting assembly housing may be mounted adjacent to, or adjacent to, a second side of the existing, conventional mirror, the two housings being mounted substantially opposite to each other. In this embodiment, the air outlet formed by the housing may be formed as a long narrow aperture that runs from a top to a bottom of the housing. The mirror assembly may be attached adjacent to the conventional mirror such that the air outlet is directed towards the conventional mirror. A hair dryer or other air blower may be mounted in an aperture of one or both housings. Further, the aperture may serve as a holster for a hair dryer, allowing for its neat convenient storage. The air outlet so formed may serve to direct an airflow along the surface of the adjacent conventional mirror, and along a surface of a mirror mounted on the second housing. This embodiment of the demisting mirror assembly may be provided, packaged and sold as a two piece device for mounting on opposite sides of existing mirrors. Further, this embodiment may have the added feature of providing two angled mirrors to supplement the front facing existing mirror.

The mirror attached to the front face of the housing may be of any size and shape that may be attached to the housing. For example, the mirror may be substantially rectangular, circular, oval shaped, and the like. The mirror may have a length and width substantially equal to the housing in one embodiment. In another embodiment, the mirror may have a length and with slightly larger than the housing to allow some overlap of the mirror from the housing. In another embodiment, the mirror may be smaller than the housing. In still another embodiment, the mirror may be hingedly attached to the housing, allowing access to the substantially hollow interior portion by pivoting about the hinge.

The mirror may be constructed of any material capable of mounting to the housing, and reflecting a substantial amount of light. Materials of which the mirror may be made include, but are not limited to, mirrored glass, mirrored plastic, polished metals, mineral composites, and the like. Preferably, the mirror may be constructed of a material that is substantially resistant to humidity, and that will not rapidly corrode in a humid environment. Further, in one embodiment it is preferable that the material of which the mirror is made be capable of transferring heat relatively rapidly, as rapid heat transfer may allow the heated air from the air blower to rapidly heat the mirror, speeding the demisting of the mirror.

The mirror may be attached to the housing by methods known to those skilled in the art. Attachment methods may include adhesive attachment, inserting the mirror into slots to hold the mirror in place, hinged connection of one side of the mirror to the housing, or passing a bolt through the mirror into the housing.

An air blower may be removably mounted and secured to the housing. The air blower may be any portable air blowing device. Preferably, the air blower may be capable of providing heated air. In one embodiment, the air blower may be a hair dryer. The air blower may be sized and shaped to be mounted, removably or permanently, at least partially through the aperture of the housing. In one embodiment wherein the air blower is a hair dryer, the aperture of the housing may serve as a storage place for the hair dryer. The air blower may utilize a power source to provide energy needed to blow air. In one embodiment, the power source may be a conventional electric wall outlet. However, other embodiments utilizing power sources such as battery power and other power sources are within the scope of this disclosure.

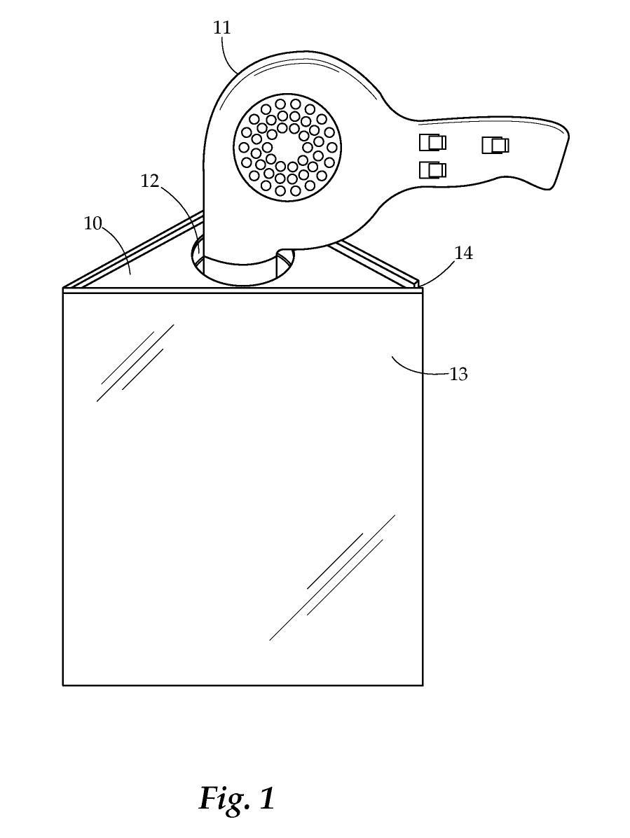

Turning now to FIG. 1, a front view of an embodiment of the mirror assembly is shown. A housing 10 forms the structure of the assembly. The housing 10 forms a front face to which a mirror 13 is attached. The housing 10 also forms a top, base, and rear side portions. Further, the housing 10 forms an aperture 12 on its top. Positioned partially within the aperture is an air blower 11, shown in this embodiment as a conventional blow dryer. The air blower 11 may be stored securely and conveniently within the aperture 12 of the housing 10. The housing 10 further defines an air outlet 14 which allows air blown by the air blower 11 to escape the interior of the housing 10.

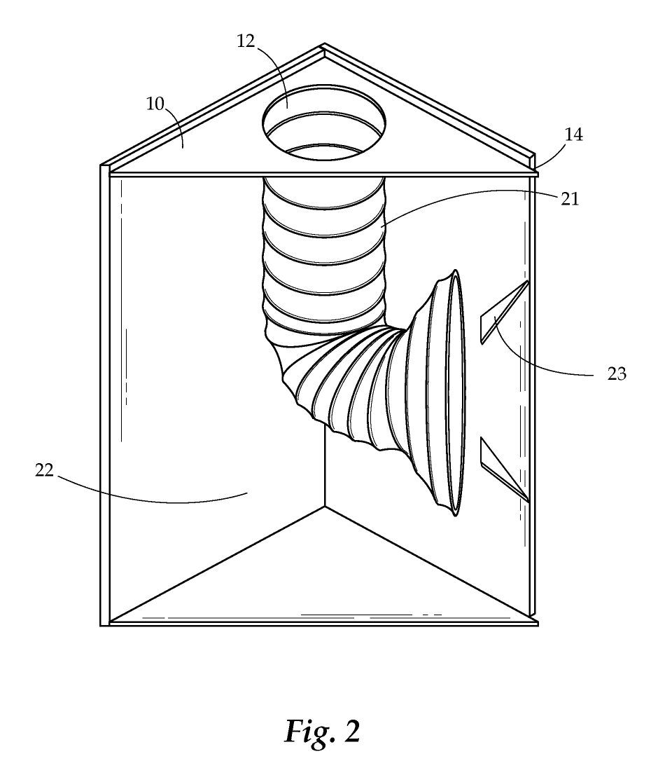

FIG. 2 shows a cutaway view showing the hollow interior of an embodiment of the mirror assembly. The housing 10 defines a hollow interior 22. In the hollow interior 22 is a duct 21. The duct 21 directs the air at the front face of the housing 10, which is cut away in this view. A first end of the duct 21 is attached to the perimeter of the aperture 12 formed by the housing 10. The right rear wall of the housing 10 is positioned slightly back from the front wall of the housing 10, which forms an air outlet 14 along the height of the housing. A second end of the duct 21 is flattened and directed to a corner of the housing 10 that has an air outlet 14. In this embodiment, a plurality of baffles 23 are positioned within the housing 10. These baffles 23 evenly direct air from the outlet of the duct 21 out of a top and bottom of the air outlet 14 as well as the center.

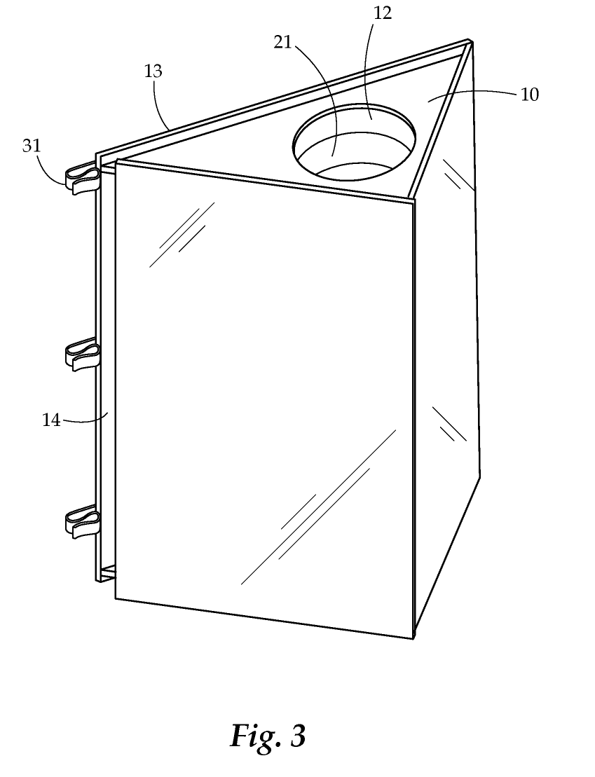

FIG. 3 provides a perspective view of a rear of an embodiment of the mirror assembly. The housing 10 is triangularly shaped and has a mirror 13 attached to a front face. The housing 10 defines an aperture 12. The aperture 12 leads to a duct 21 which directs air blown into the aperture 12. The housing 10 further defines an air outlet 14 which allows air to escape from the interior of the housing 10. A cord guide 31 is attached to an edge of the housing 10. The cord guide 31 may serve to guide a cord of the air blower (not shown) to allow for its neat, tidy and convenient storage.

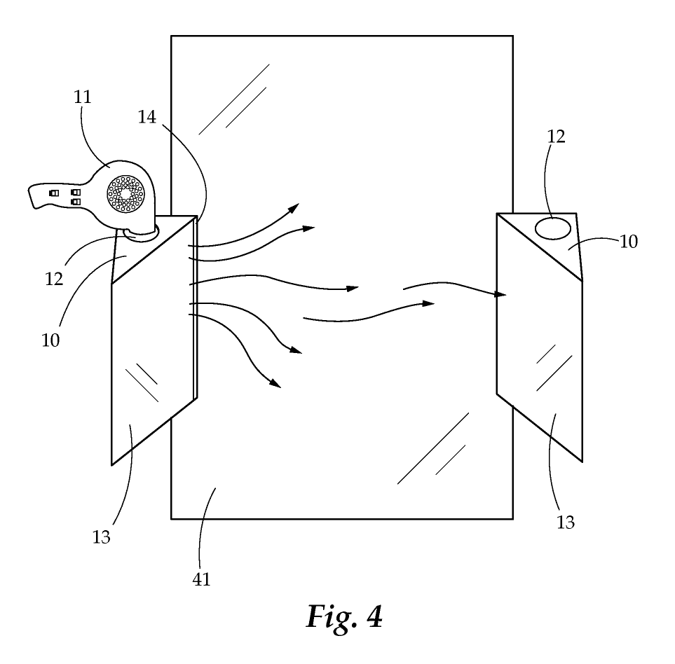

FIG. 4 provides a view of two demisting mirrors mounted on opposite sides of an existing mirror. A housing 10 of a first and second demisting mirror is mounted to an existing mirror 41. The mirrors 13 of the two housings 10 are angled approximately 45 degrees away from the plane of the existing mirror 14. An aperture 12 is formed by the housing 10 of the first and second demisting mirrors. In the aperture 12 of the first demisting mirror housing 10, a hair dryer 11 is inserted. When the hair dryer 11 is activated, it blows air into the housing 10, out of air outlet 14, across a surface of the existing mirror 41, and over to the mirror 13 of the second demisting mirror. The air is shown in this figure as curved lines.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A demisting mirror assembly comprising:
a housing forming a substantially hollow interior portion;
an air blower removably mounted to the housing, an outlet of the air blower positioned within the substantially hollow interior portion of the housing;
an aperture formed by the housing providing fluid communication between the substantially hollow interior and an outside of the housing, the aperture sized to receive at least a portion of the air blower;
a mirror attached to a front face of the housing; and
wherein the aperture formed by the housing is formed by a surface of the housing that allows the housing to secure the air blower.

2. The demisting mirror assembly of claim 1 wherein the air blower is a hair dryer.

3. The demisting mirror assembly of claim 2 wherein the hair dryer further comprises a heating element, positioned along an air flow path of the hair dryer.

4. The demisting mirror assembly of claim 3 further comprising an air outlet formed by the housing, the air outlet providing fluid communication between the substantially hollow interior of the housing and the outside of the housing.

5. The demisting mirror assembly of claim 4 further comprising a duct positioned within the substantially hollow interior portion of the housing.

6. The demisting mirror assembly of claim 3 wherein the aperture is formed by the housing as a holster to allow the hair dryer to be stored in the demisting mirror assembly.

7. The demisting mirror assembly of claim 5 further comprising a baffle positioned between an end of the duct and the air outlet.

8. The demisting mirror assembly of claim 3 wherein the housing further comprises a cord guide to secure a cord of the hair dryer.

9. The demisting mirror assembly of claim 3 wherein the air outlet is formed by the housing as a narrow slit along a vertical height of the housing.

10. The demisting mirror assembly of claim 3 wherein the housing is positioned adjacent to a conventional mirror; and
wherein the air outlet formed by the housing directs a quantity of outlet air towards the conventional mirror.

11. The demisting mirror assembly of claim 10 further comprising a second housing positioned adjacent to the conventional mirror on a substantially opposite side from the housing.

12. The demisting mirror assembly of claim 3 wherein the mirror is hingedly attached to an edge of the housing.

13. The demisting mirror assembly of claim 3 wherein the housing is constructed of a mirrored material.

14. A demisting apparatus for an existing mirror comprising:
a housing forming a substantially hollow interior portion, the housing positioned adjacent to a first side of the existing mirror;
an aperture formed by the housing, the aperture sized to receive at least a portion of an air blower;
the air blower being removably mounted to the housing, an outlet of the air blower positioned within the substantially hollow interior portion of the housing;
an air outlet formed by the housing, the air outlet positioned on a face of the housing that is directed at a surface of the existing mirror;
a second mirror attached to a front face of the housing; and
wherein the aperture formed by the housing is constructed and arranged as a holster for the removable storage of the air blower.

15. The demisting apparatus for an existing mirror of claim 14 wherein the air blower is a hair dryer, the hair dryer comprising a heating element, positioned along an air flow path of the hair dryer.

16. The demisting apparatus for an existing mirror of claim 16 wherein the housing further comprises a cord guide to secure a cord of the hair dryer.

17. The demisting apparatus for an existing mirror of claim 16 further comprising a duct positioned within the substantially hollow interior portion of the housing, the duct constructed and arranged to direct air from the hair dryer out of the air outlet and across the existing mirror.

18. The demisting apparatus for an existing mirror of claim 16 wherein the air outlet is formed by the housing as a narrow slit along the height of the housing.

19. The demisting apparatus of claim 15 further comprising a second housing positioned adjacent to a second side of the existing mirror, the second side being opposite to the first side of the existing mirror.

20. A mirror assembly comprising:
a first housing forming a substantially hollow interior portion;
a hair dryer removably mounted to the first housing, an outlet of the hair dryer positioned within the substantially hollow interior portion of the first housing;
an aperture formed by the first housing, the aperture sized to receive at least the outlet of the hair dryer, and being constructed and arranged as a holster for the removable storage of the hair dryer, wherein the hair dryer is stored by resting in the aperture,;
an air outlet formed by the first housing, providing fluid communication between the substantially hollow interior of the first housing with an outside of the housing;
a mirror attached to a front face of the first housing;
a duct positioned within the substantially hollow interior portion of the first housing, the duct constructed and arranged to direct air from the hair dryer out of the air outlet;
a cord guide to secure a cord of the hair dryer the cord guide attached to the first housing;
wherein the hair dryer further comprises a heating element positioned along an air flow path of the hair dryer;
the first housing mounted to a first side of an existing mirror;
a second housing forming a substantially hollow interior portion;
an aperture formed by the second housing, the aperture sized to receive at least the outlet of the hair dryer, and being constructed and arranged as a holster for the removable storage of the hair dryer, wherein the hair dryer is stored by resting in the aperture,;
an air outlet formed by the second housing, providing fluid communication between the substantially hollow interior of the second housing with an outside of the housing;
a mirror attached to a front face of the second housing;
a duct positioned within the substantially hollow interior portion of the second housing, the duct constructed and arranged to direct air from the hair dryer out of the air outlet;
the second housing attached to a second side of the existing mirror.
